(19) United States
(12) Patent Application Publication
(10) Pub. No.: US 2026/0175530 A1
(43) Pub. Date: Jun. 25, 2026

(54) SYSTEM AND METHOD FOR BLOW MOLDING PLATE COMPONENTS FOR ARTICLES OF FOOTWEAR

(71) Applicant: NIKE, Inc., Beaverton, OR (US)

(72) Inventors: Jeremy D. Walker, Portland, OR (US); James M.F. Webster, Tigard, OR (US)

(73) Assignee: NIKE, Inc., Beaverton, OR (US)

(21) Appl. No.: 19/427,046

(22) Filed: Dec. 19, 2025

Related U.S. Application Data
(60) Provisional application No. 63/737,070, filed on Dec. 20, 2024.
(60) Provisional application No. 63/864,036, filed on Aug. 14, 2025.

(51) Int. Cl. B29D 35/14; B29C 49/00; B29C 49/04; B29C 49/22; B29L 31/50

(52) U.S. Cl. CPC B29D 35/142; B29C 49/0005; B29C 49/04; B29C 49/22; B29L 2031/504

(57) ABSTRACT

A blow molding system includes an extrusion system with at least one extruder that is configured to extrude a parison with an interior cavity. A stopper is operably coupled to one of the at least one extruder and can be operated between an open and a closed state. The parison features an outer layer and at least one inner layer that is different from the outer layer. The extruder is configured with a nozzle to selectively extrude the outer layer when the stopper is in the open state. The system also includes a blow pin that extends into the interior cavity of the extruded parison and a mold assembly that defines a mold chamber. The parison is received within this mold chamber, and the mold assembly includes multiple mold cavities that each face the chamber and define a profile of a sole component for an article of footwear.

### CROSS-REFERENCE TO RELATED APPLICATIONS

This U.S. patent application claims priority under 35 U.S.C. § 119(e) to U.S. Provisional Application 63/864,036, filed Aug. 14, 2025 and U.S. Provisional Application 63/737,070, filed on Dec. 20, 2024. The disclosures of these prior applications are considered part of the disclosure of this application and are hereby incorporated by reference in their entirety.

### FIELD

The present disclosure relates generally to a system for molding a sole plate for an article of footwear, and more particularly, to a system for simultaneously blow molding a plurality of sole plates for articles of footwear.

### BACKGROUND

This section provides background information related to the present disclosure and is not necessarily prior art.

Articles of footwear conventionally include an upper and a sole structure. The upper may include any suitable material(s) to receive, secure, and support a foot on the sole structure. The upper may cooperate with laces, straps, or other fasteners to adjust the fit of the upper around the foot. A bottom portion of the upper, proximate to a bottom surface of the foot, attaches to the sole structure.

Sole structures generally include a layered arrangement extending between a ground surface and the upper. One layer of the sole structure includes an outsole that provides abrasion-resistance and traction with the ground surface. The outsole may include a sole plate formed of a rigid or semi-rigid material that provides rigidity and energy distribution across the sole structure. The sole plate may be provided with one or more types of traction elements for maximizing engagement with a ground surface. In some cases, the traction elements may be fixed to the outsole plate or integrally molded with the sole plate. Sole plates are typically manufactured using injection molding processes.

### DRAWINGS

The drawings described herein are for illustrative purposes only of selected configurations and not all possible implementations, and are not intended to limit the scope of the present disclosure.

FIG. 1 is a schematic view showing a cross section of an example configuration of a blow molding system in accordance with the principles of the present disclosure;

FIG. 2A is a schematic view showing the cross section of the blow molding system of FIG. 1, where a first amount of molding material is extruded into a mold as a parison;

FIG. 2B is a schematic view showing the cross section of the blow molding system of FIG. 1, where a second amount of molding material is extruded into a mold as a parison;

FIG. 2C is a schematic view showing the cross section of the blow molding system of FIG. 1, where the first amount of molding material is extruded into a mold as a parison;

FIG. 3 is a schematic view showing the cross section of the blow molding system of FIG. 1, where a mold assembly is moved to a closed configuration;

FIG. 4 is a schematic view showing the cross section of the blow molding system of FIG. 1, wherein the parison is expanded into mold cavities of the mold;

FIG. 5 is a schematic view showing the cross section of the blow molding system of FIG. 1, wherein the mold is opened for removal of a molded article;

FIG. 6 is a perspective view of the molded article of FIG. 5, showing a step of separating molded article sections;

FIG. 7 is a perspective view of the separated molded article sections of FIG. 6;

FIG. 8 is a perspective view of one of the separated molded article sections of FIG. 7, showing a sole plate being removed from the molded article section; and

FIG. 9 is a perspective view of an article of footwear equipped with a sole component according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

An aspect of the disclosure provides a blow molding system comprising: a first extruder suitable for extruding a first material; a second extruder suitable for extruding a second material, the second material cooperating with the first material to form a parison; a stopper coupled to the first extruder and operable between an open state and a closed state, the stopper permitting passage of the first material through an extrusion path in the open state and preventing passage of the first material through the extrusion path in the closed state; and a mold assembly operable between a first configuration defining a mold chamber and a second configuration having an opening at one end that receives the parison, the mold assembly including a plurality of mold cavities each facing the mold chamber and defining a profile of at least one sole component of an article of footwear.

Aspects of the disclosure may include one or more of the following optional features. In some aspects, the first extruder forms a first layer of the parison and the second extruder forms a second layer of the parison, the first layer being concentric with the second layer. In some examples, the first extruder selectively forms the first layer on the second layer when the stopper is in the open state to provide the parison with a first portion having the first layer and the second layer and a second portion having only the second layer. In some implementations, the system further comprises a third extruder extruding a third material, which forms a third layer of the parison. In some configurations, the second and third extruders are disposed upstream of the first extruder. In some aspects, an outlet of the third extruder is disposed proximate to an inner surface of the second layer of the parison to form the third layer on the inner surface of the second layer, making the third layer concentric with the second layer. In some examples, the first material is different than at least one of the second material and the third material, while in other instances, it can be the same. In some implementations, the plurality of mold cavities includes a first mold cavity defining a profile of a first sole plate of an article of footwear and a second mold cavity defining a profile of a second sole plate of an article of footwear and having a different configuration than the first sole plate. In some configurations, a controller is operably coupled with the stopper and translates the stopper between the open state and the closed state to selectively apply the first material to an outer surface of the second material.

An aspect of the disclosure provides a method of forming a plurality of sole plates for an article of footwear, the method comprising: extruding a first material and forming a first layer of a parison; moving a stopper into an open state, extruding a second material, and forming a second layer of the parison; moving the stopper into a closed state and preventing extrusion of the first material at one or more predetermined locations along a length of the first layer; and expanding the parison in a mold chamber having a plurality of mold cavities to conform the parison to the plurality of the mold cavities and form a molded article including the plurality of the sole plates.

Aspects of the disclosure may include one or more of the following optional features. In some aspects, moving the stopper into the open state and extruding the second material includes forming an outer layer of the parison. In some examples, extruding the first layer and the second layer includes extruding the same material. In some implementations, extruding the first layer and the second layer includes extruding different materials. In some configurations, the method further comprises extruding a third material and forming a third layer of the parison. In some aspects, forming the third layer includes forming the third layer on an opposite side of the first layer than the second layer. In some examples, forming the third layer includes forming the third layer concentric with the second layer. In some implementations, the method further comprises separating the plurality of sole plates from one another. In some configurations, the method also comprises incorporating at least one sole plate of the plurality of sole plates into a sole structure.

The present disclosure provides a system and method for blow molding polymer components for articles of footwear, and particularly, multi-layer sole plates for articles of footwear. Conventionally, sole plates and other polymeric components of footwear are manufactured using injection molding processes, or in some instances, additive manufacturing (e.g., three-dimensional printing). While suitable, injection molding processes can be relatively costly due to the complexity of molds and molding materials. Additionally, injection molding processes may limit the types of materials that can be used, as some chemistries of materials are not compatible with each other when combined in an injection molding process. Further, these processes can be time and labor intensive. Blow molding is a low-cost and efficient manufacturing method that enables lightweight products to be manufactured that can be mono-layer or multi-layer, thereby enabling unique material combinations to be achieved in a single process. Additionally, molds associated with blow molding systems are typically less expensive relative to molds associated with injection molding processes. As discussed herein, the molds used with blow molding processes may include multiple mold plates for forming a plurality of mold plates simultaneously. Use of extruded materials in a blow molding process also enables the option of incorporating recycled content or foamed layers within the center layers of a sole plate, thereby improving sustainability while maintaining desired aesthetics and performance qualities.

The details of one or more implementations of the disclosure are set forth in the accompanying drawings and the description below. Other aspects, features, and advantages will be apparent from the description, the drawings, and the claims.

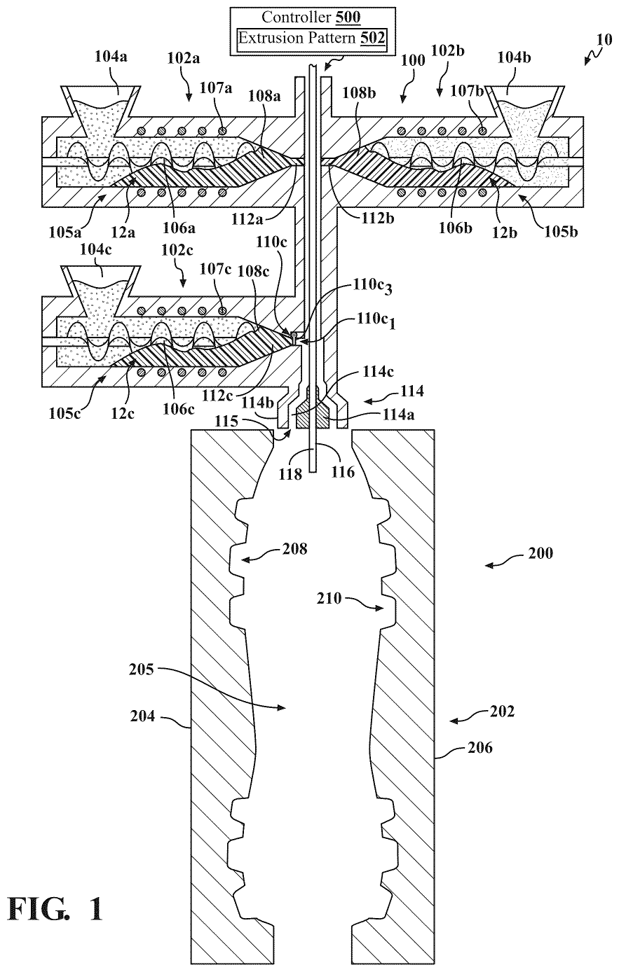

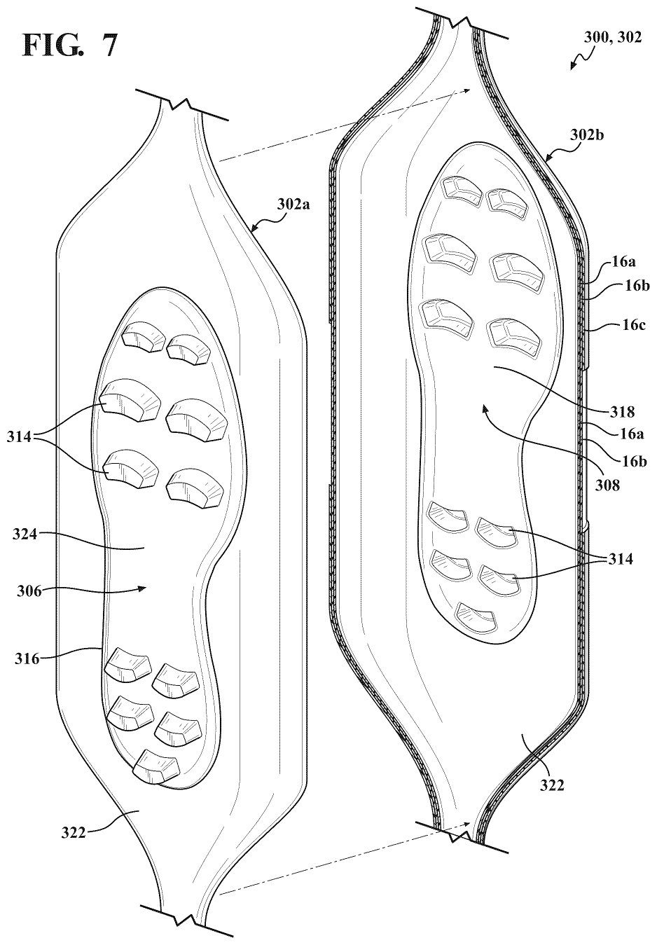

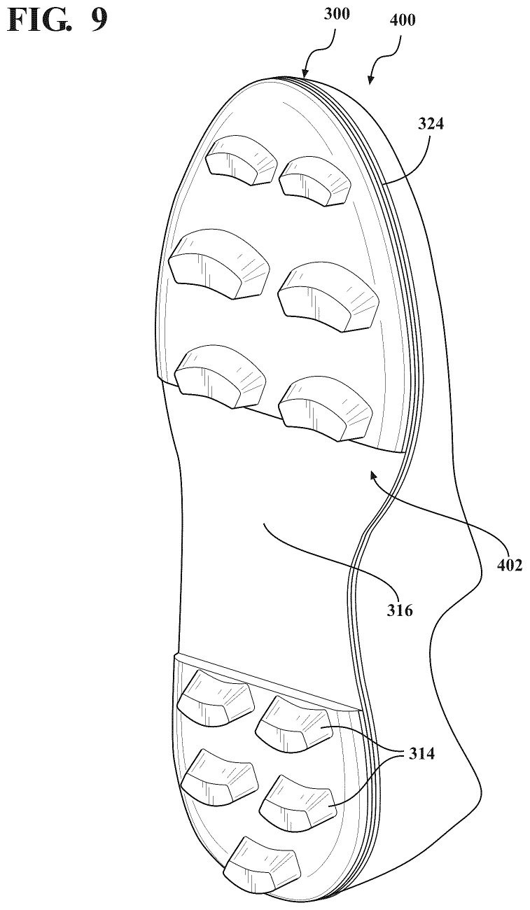

Referring to FIGS. 1-5, a blow molding system 10 is provided according to an example of the present disclosure. The blow molding system 10 includes an extrusion system 100 and a mold system 200 configured to produce a blow-molded article 300 including one or more footwear components. For example, in some configurations, the footwear components may include a plurality of sole plates 306, 308 (FIG. 7) for use in manufacturing a sole component of an article of footwear 400 (FIG. 9). Thus, the plurality of the sole plates 306, 308 can be simultaneously formed by the blow molding system 10. In alternative configurations, the footwear component may include other components or portions of an article of footwear, such as heel counters, integral sole plates, integral heel counter units, or any other practicable footwear component that may be produced using the blow molding system.

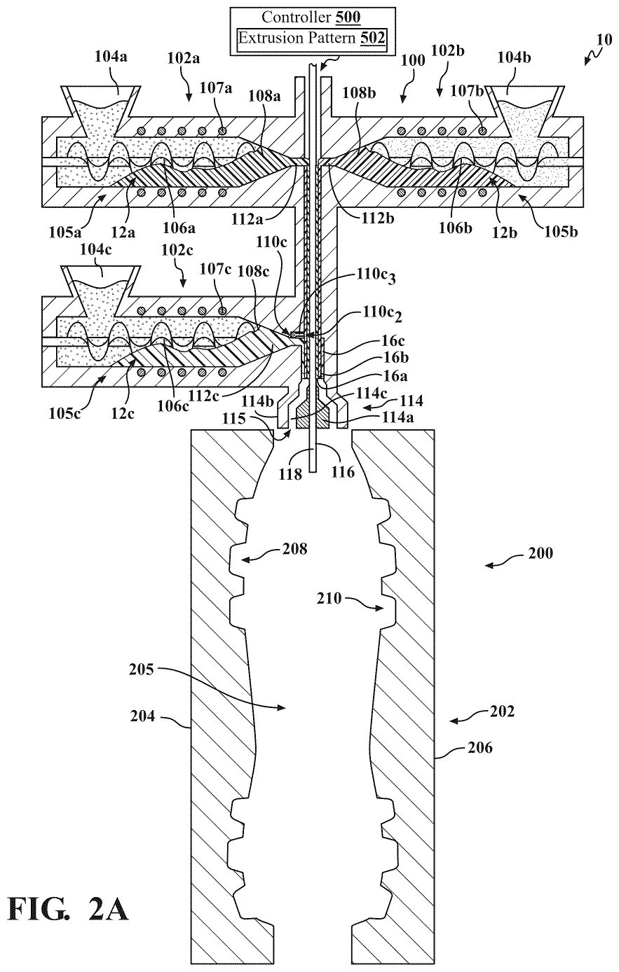

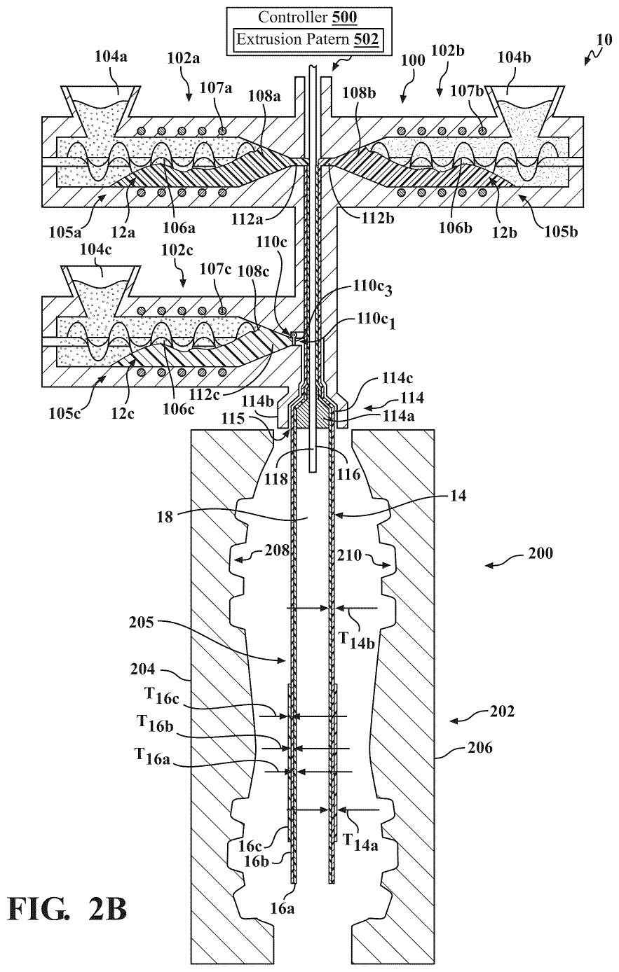

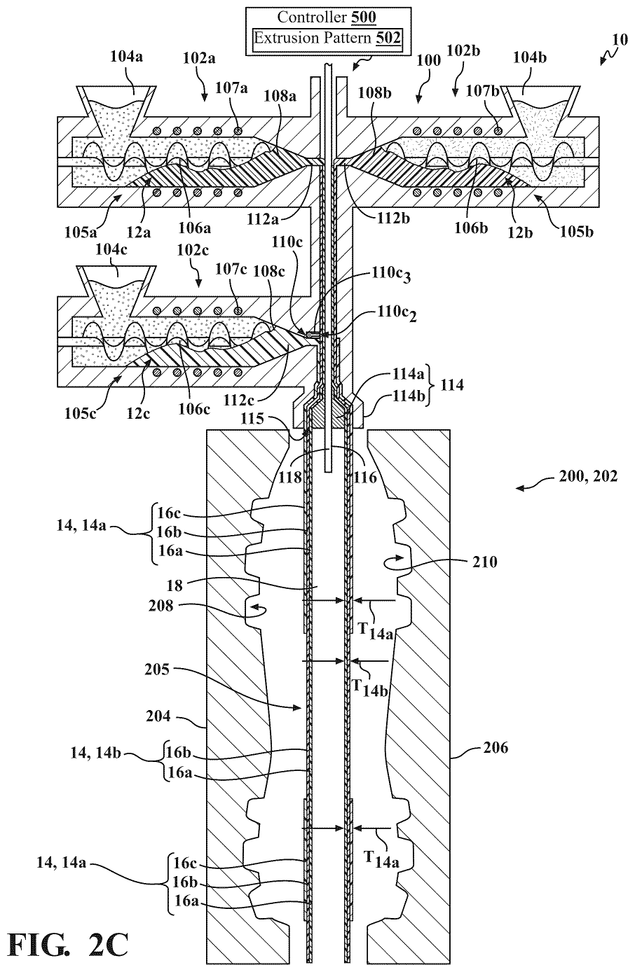

Referring to FIGS. 1-2C, the extrusion system 100 includes one or more extruders 102a-102c, including a first extruder 102a configured to extrude a first mold material 12a, a second extruder 102b configured to extrude a second mold material 12b, and a third extruder 102c configured to extrude a third mold material 12c. In this configuration, the first material 12a and the second material 12b may be encapsulated or interposed within the third mold material 12c. While the illustrated example is provided with first, second, and third extruders 102a-102c, for the sake of clarity, it should be appreciated that the extrusion system 100 may include less extruders or additional extruders as desired.

The first extruder 102a includes a first hopper 104a for receiving the first mold material 12a in a raw form, such as, but not limited to, in a pellet form, powder form, shaving form, molten form or any other practicable raw form of the first material 12a. The first extruder 102a further includes an extruder barrel 105a including a first extruder screw 106a and a heating element 107a for heating the first mold material 12a to a molten state. The extruder barrel 105a includes a first nozzle 108a disposed at an end of the first extruder screw 106a for receiving the molten first mold material 12a.

The second extruder 102b includes a second hopper 104b for receiving the second mold material 12b in a raw form, such as, but not limited to, in a pellet form, powder form, shaving form, molten form or any other practicable raw form of the second material 12b. The second extruder 102b further includes an extruder barrel 105b including a second extruder screw 106b and a heating element 107b for heating the second mold material 12b to a molten state. The extruder barrel 105b includes a second nozzle 108b disposed at an end of the second extruder screw 106b for receiving the molten second mold material 12b.

The third extruder 102c includes a third hopper 104c for receiving the third mold material 12c in a raw form, such as, but not limited to, in a pellet form, powder form, shaving form, molten form or any other practicable raw form of the third material 12c. The third extruder 102c further includes an extruder barrel 105c including a third extruder screw 106c and a heating element 107c for heating the third mold material 12c to a molten state. The extruder barrel 105c includes a third nozzle 108c disposed at an end of the third extruder screw 106c for receiving the molten third mold material 12c. The third extruder 102c also includes a stopper 110c that is positioned at the nozzle 108c. The stopper 110c is selectively operable between a closed state 110c₁ (FIG. 1) and an open state 110c₂ (FIG. 2A). For example, the stopper 110c includes a flange 110c₃ that prevents extrusion of the third mold material 12c when the stopper 110c is in the closed state 110c₁. The first mold material 12a and the second mold material 12b are permitted to be extruded regardless of the state of the stopper 110c. The stopper 110c is utilized by the third extruder 102c to selectively extrude the third material 12c. For example, FIG. 2A illustrates the stopper 110c in the open state 110c₂, such that the third material 12c may be extruded around the first and second materials 12a, 12b. The stopper 110c may subsequently be transitioned to the closed state 110c₁ to prevent the third material 12c from being extruded, such that only the first material 12a and the second material 12b are extruded as the parison 14, as illustrated in FIG. 2B. FIG. 2C illustrates the stopper 110c once again in the open state 110c₂ with the third material 12c being extruded around the first material 12a and the second material 12b. Thus, the third material 12c may be selectively extruded to define areas of the molded article 300 that are thicker as compared to other portions of the molded article 300, described in more detail below.

The extrusion system 100 may also include a controller 500 configured with an extrusion pattern 502 and is operably coupled with the stopper 110c of the third extruder 102c. The controller 500 may also be operably coupled with each of the first extruder 102a and the second extruder 102b to control or otherwise execute extrusion functions of the first extruder 102a and the second extruder 102b. With respect to the third extruder 102c, the controller 500 is configured to selectively translate the stopper 110c between the closed state 110c₁ and the open state 110c₂ as part of execution of the extrusion pattern 502. For example, the controller 500 may be configured with a predetermined extrusion pattern 502 that indicates when the stopper 110c should be in the open state 110c₂ and when the stopper 110c should be in the closed state 110c₁.

Each of the nozzles 108a-108c of the extruders 102a-102c may be in communication with a corresponding manifold 112a-112c, which provides a passageway for the respective mold materials 12a-12c to an end die 114 of the extrusion system 100. The end die 114 includes an inner portion 114a and an outer portion 114b. The inner portion 114a is received by the outer portion 114b and is moveable relative to the outer portion 114b. For example, the inner portion 114a may be attached or otherwise operably coupled to a screw or other adjustment mechanism to raise and lower the inner portion 114a relative to the outer portion 114b of the end die 114. The inner portion 114a is at least partially spaced apart from the outer portion 114b to define a gap 114c at the end die 114. The gap 114c may be selectively increased or decreased depending on the position of the inner portion 114a relative to the outer portion 114b to adjust a thickness of the mold materials 12a, 12b extruded at the end die 114.

The manifolds 112a-112c are configured to introduce the mold materials 12a-12c to the end die 114 in a sequential manner, whereby the first mold material 12a is provided to the end die 114 upstream of the second mold material 12b, and the second mold material 12b is provided to the end die 114 upstream of the third mold material 12c. The stopper 110c is positioned at the manifold 112c of the third extruder 102c to selectively introduce the third material 12c to the end die 114. For example, the third material 12c may be introduced to provide added material at areas that may ultimately have higher levels of abrasion or wear during use of the end molded article 300. The second mold material 12b is layered upon an outer surface of the first mold material 12a to form layers 16a, 16b of a coextruded parison 14 including both materials 12a, 12b. The third mold material 12c is selectively layered upon an outer surface of the second mold material 12b to form an outer layer 16c of the coextruded parison 14 surrounding layers 16a, 16b.

In other words, the first mold material 12a and the third mold material 12c form outer layers 16a, 16c of the parison 14 relative to the second mold material 12b, which forms an inner layer 16b of the parison 14 relative to the outer layers 16a, 16c of the parison 14. The first material 12a and the second material 12b are deposited upstream of the third material 12c, and the third material 12c forms a concentric outer layer 16c around the first material 12a and the second material 12b. The third material 12c surrounds the concentric inner layers 16a, 16b to define the outer layer 16c. The third material 12c is extruded as a tube around the first material 12a and the second material 12b. While the illustrated example of the extrusion system 100 is configured for extruding three layers 16a-16c of mold materials 12a-12c, it will be appreciated that molding systems having other configurations may be utilized. For example, the extrusion system 100 may be configured to coextrude a parison 14 including four or more layers 16a-16c.

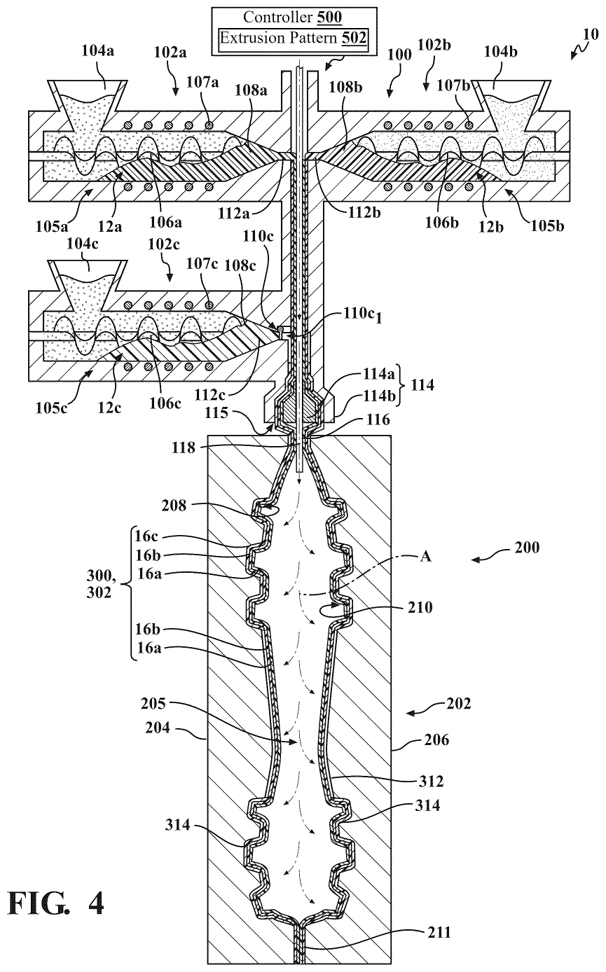

Referring still to FIGS. 1-2C, the extrusion system 100 includes a blow pin 116 positioned within the end die 114 and extending from an outlet end 115 of the end die 114. The blow pin 116 is configured to extend within an interior cavity 18 of the parison 14 and into the mold system 200. While the illustrated example shows the layers 16a-16c of the parison 14 being directly adjacent to the blow pin 116, other extrusion systems 100 may be configured such that the layers 16a-16c of the parison 14 are spaced radially outwardly from the blow pin 116 and may be separated from the blow pin 116 by a portion of the end die 114 (e.g., an annular spacer). The blow pin 116 is configured to receive a pressurized fluid (e.g., air) for injection into the interior cavity 18 of the parison 14 to expand the parison 14 within the mold system 200, as described below with respect to FIG. 4.

In some example configurations, the extrusion system 100 can be a co-extrusion system configured to produce a multi-layer parison 14. For instance, the system 100 may employ a co-extrusion head, such as a 90 mm single parison head, capable of processing multiple material layers simultaneously. This head may be configured to produce a parison with a significant number of layers, for example, seven, eight, or even more distinct layers. The extrusion system 100 can be adapted to include extruders of varying sizes to accommodate different material requirements for each layer of the parison 14. For example, a main extruder, which may be a larger extruder, could be used for a primary interior layer. Smaller extruders may be used for the inner and outer layers 16a, 16c, while other intermediate layers could be supplied by even smaller extruders. To ensure proper processing and extrusion of the various materials 12a-12c, the extruders 102a-102c may be equipped with different types of extruder screws. For many of the layers, general-purpose polyethylene (PE) screws may be suitable. However, for certain specialized layers, such as barrier layers designed to prevent material migration or provide specific mechanical properties, specialized barrier screws may be employed to ensure optimal melt quality and layer formation.

As set forth above, the extrusion system 100 is configured to coextrude the first, second, and third materials 12a-12c. While the materials 12a-12c may be the same, an advantage of the extrusion system 100 is that it allows different materials to be coextruded as unique layers of the parison 14. For example, the layers 16a-16c of the parison 14 can include an elastomeric material that includes one or more thermoplastic polymers and/or one or more cross-linkable polymers. In other instances, each of the layers 16a-16c may include the elastomeric material. In an aspect, the elastomeric material can include one or more thermoplastic elastomeric materials, such as one or more thermoplastic polyurethane (TPU) copolymers, one or more ethylene-vinyl alcohol (EVOH) copolymers, and the like.

As used herein, “polyurethane” refers to a copolymer (including oligomers) that contains a urethane group (—N(C═O)O—). These polyurethanes can contain additional groups such as ester, ether, urea, allophanate, biuret, carbodiimide, oxazolidinyl, isocynaurate, uretdione, carbonate, and the like, in addition to urethane groups. In an aspect, one or more of the polyurethanes can be produced by polymerizing one or more isocyanates with one or more polyols to produce copolymer chains having (—N(C═O)O—) linkages.

Examples of suitable isocyanates for producing the polyurethane copolymer chains include diisocyanates, such as aromatic diisocyanates, aliphatic diisocyanates, and combinations thereof. Examples of suitable aromatic diisocyanates include toluene diisocyanate (TDI), TDI adducts with trimethyloylpropane (TMP), methylene diphenyl diisocyanate (MDI), xylene diisocyanate (XDI), tetramethylxylylene diisocyanate (TMXDI), hydrogenated xylene diisocyanate (HXDI), naphthalene 1,5-diisocyanate (NDI), 1,5-tetrahydronaphthalene diisocyanate, para-phenylene diisocyanate (PPDI), 3,3′-dimethyldipheny1-4,4′-diisocyanate (DDDI), 4,4′-dibenzyl diisocyanate (DBDI), 4-chloro-1,3-phenylene diisocyanate, and combinations thereof. In some embodiments, the copolymer chains are substantially free of aromatic groups.

In particular aspects, the polyurethane polymer chains are produced from diisocynates including HMDI, TDI, MDI, H12 aliphatics, and combinations thereof. In an aspect, the thermoplastic TPU can include polyester-based TPU, polyether-based TPU, polycaprolactone-based TPU, polycarbonate-based TPU, polysiloxane-based TPU, or combinations thereof.

In another aspect, the polymeric layers can be formed of one or more of the following: EVOH copolymers, poly(vinyl chloride), polyvinylidene polymers and copolymers (e.g., polyvinylidene chloride), polyamides (e.g., amorphous polyamides), amide-based copolymers, acrylonitrile polymers (e.g., acrylonitrile-methyl acrylate copolymers), high-density polyethylene, polyethylene terephthalate, polyether imides, polyacrylic imides, and other polymeric materials. Blends of these materials as well as with the TPU copolymers described herein and optionally including combinations of polyimides and crystalline polymers, are also suitable.

In some examples, where a first material 12a and a second material 12b are selected that are incompatible (e.g., do not naturally bond to each other in a molten state), the extrusion system 100 may include an intermediate extruder configured to extrude an intermediate adhesive material for bonding the first material 12a to the second material 12b. Thus, the parison 14 may comprise two or more layers (multilayer extrusion) joined by an adhesive. Additionally or alternatively, the extrusion system 100 may include one or more extruders configured to extrude an adhesive material adjacent to the exposed surfaces of the inner layers 16a, 16b. For example, an adhesive layer may be extruded and applied to an exposed surface of the outer layer 16c corresponding to a footbed of the sole plate 306, 308, whereby the adhesive enables adhesion of the sole plate 306, 308 to an upper (e.g., to the strobel). Optionally, an adhesive layer may be extruded and applied to an exposed surface of the outer layers 16a, 16b corresponding to a ground-engaging surface of the sole plate 306, 308 (FIG. 7), whereby the adhesive enables adhesion of one or more traction elements to the ground-engaging surface of the sole plate 306, 308. In further configurations, the parison 14 may comprise alternating layers of one or more first copolymer materials and one or more second copolymer materials, where the total number of layers in the parison 14 includes at least four (4) layers, and/or at least ten (10) layers.

In some examples, the first material 12a, the second material 12b, or the third material 12c may include recycled or upcycled materials, which may be obtained from reclaimed scrap of prior extrusions. Recycled material is understood to be distinguishable from “virgin” materials that have never been utilized in a manufacturing process. Upcycled material is understood to be materials that are repurposed without being broken down into raw materials. In configurations utilizing a recycled or reclaimed material, the parison 14 may be formed with four or more layers 16a-16c, including inner and outer layers 16a-16c including virgin first material 12a, second material 12b, or third material 12c, and an intermediate layer including the recycled second material interposed between the inner and outer layers 16a-16c. Thus, the parison 14 and the resulting sole plates 306, 308 will include a portion of recycled material concealed between virgin material layers 16a-16c. Thus, the resulting sole plates 306, 308 provide the benefits of using sustainable materials while maintaining the exterior aesthetics associated with virgin materials.

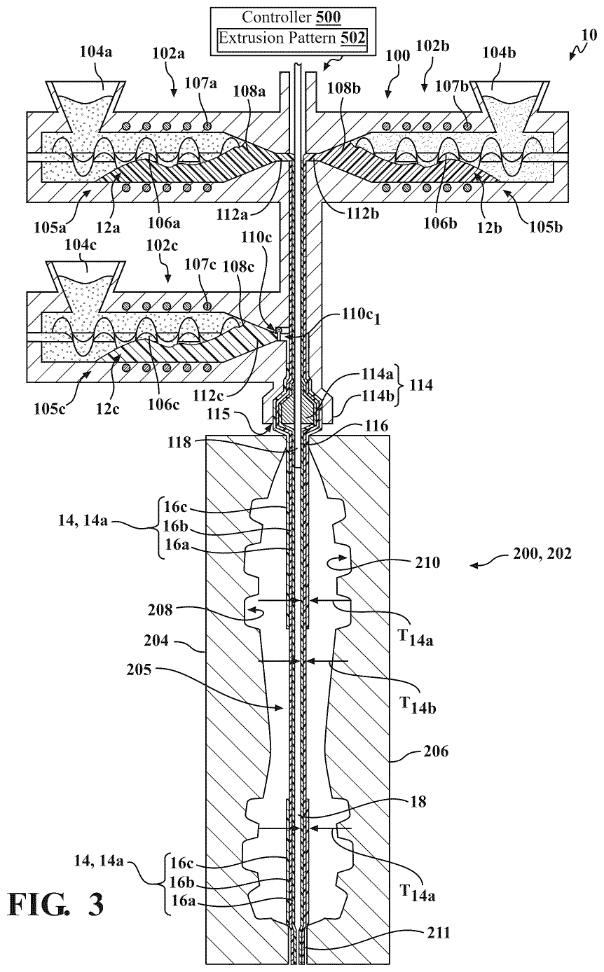

Referring still to FIGS. 1-2C, the blow molding system 10 further includes a mold system 200 including a mold assembly 202 operable between an open configuration (FIG. 2A) and a closed configuration (FIG. 3). The mold assembly 202 includes a first mold plate 204 and a second mold plate 206, which are configured to interface with each other in the closed configuration to define a mold chamber 205 configured to receive the parison 14. The first mold plate 204 defines a first mold cavity 208 corresponding to the profile of a first sole plate 306 to be molded using the blow molding system 10. The second mold plate 206 defines a second mold cavity 210 corresponding to the profile of a second sole plate 308 to be molded using the blow molding system 10. For example, the mold cavities 208, 210 may define a profile of a sole component 402 of the article of footwear 400 (FIG. 9). In the illustrated example, the first mold cavity 208 and the second mold cavity 210 are mirror images of each other, whereby the first mold cavity 208 is configured for molding a first sole plate 306 corresponding to a left-footed article of footwear and the second mold cavity 210 is configured for molding a second sole plate 308 corresponding to a right-footed article of footwear. Thus, the mold assembly 202 is configured to simultaneously mold a pair of the mold plates 204, 206 for a single pair of footwear. In other examples, the mold cavities 208, 210 may have the same configuration (e.g., both left-footed) or may have different configurations or profiles (e.g., different sizes, shapes, and/or arrangements of traction elements). Further, while the illustrated example shows mold plates 204, 206 each defining a single mold cavity 208, 210, the mold plates 204, 206 may be configured to include two or more of the mold cavities 208, 210. Further, while the mold cavities 208, 210 of the illustrated example are provided as “female” or negative mold cavities, the mold plates 204, 206 may include “male” or positive mold geometries.

The mold plates 204, 206 are configured to interface with each other in the closed configuration (FIG. 3) to form a peripheral seal 211 around the parison 14. Thus, a peripheral portion of the parison 14 may be compressed between the mold plates 204, 206 when the mold plates 204, 206 are in the closed configuration. As shown, the mold plates 204, 206 are also configured to form a peripheral seal 211 between the blow pin 116 and the parison 14 at an entry to the mold chamber 205 to prevent fluid from escaping the mold chamber 205 during the blow molding process.

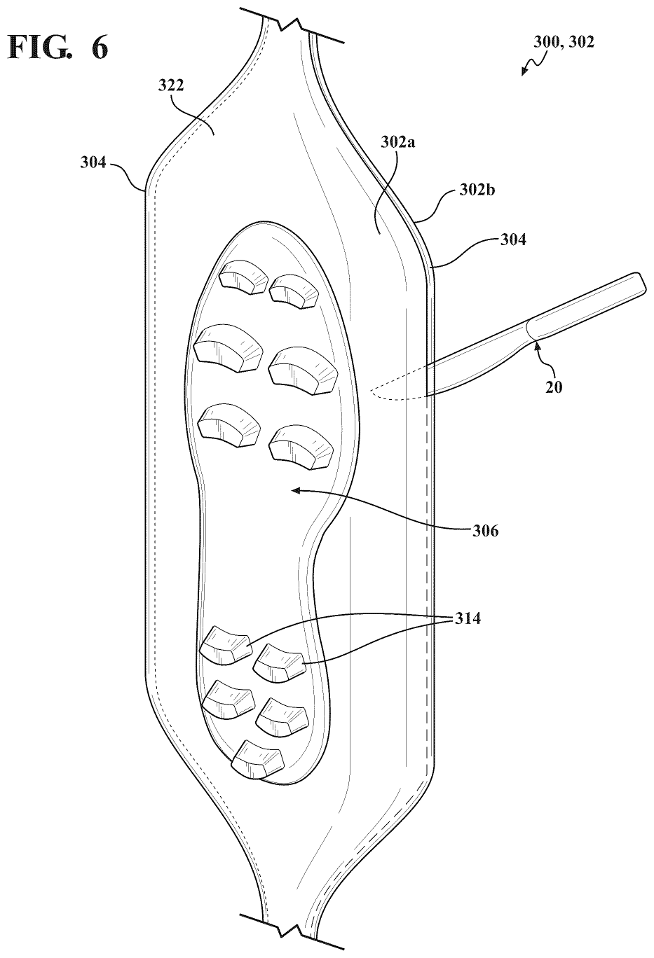

Referring to FIGS. 2A-2C, a first step of forming a molded article 300 according to the present disclosure is shown. In FIGS. 2A-2C, the mold assembly 202 is initially provided in the open configuration, whereby the mold plates 204, 206 are spaced apart from each other to open the mold chamber 205. The extrusion system 100 extrudes the parison 14 including the one or more layers 16a-16c of materials 12a-12c between the mold plates 204, 206 and through the mold chamber 205. Depending on the final configuration of the molded article 300 (FIG. 6), the stopper 110c may be selectively activated to introduce the third material 12c as a tube surrounding the deposited first and second materials 12a, 12b. As shown, a distal end of the parison 14 extends beyond the mold chamber 205 and is aligned with ends of the mold plates 204, 206. The first and second extruders 102a, 102b are upstream from the third extruder 102c, such that the first material 12a and the second material 12b are deposited upstream of the third material 12c as concentric layers 16a, 16b. The third material 12c is provided as a concentric tube of material 12c deposited around the concentric layers 16a, 16b.

FIGS. 2A-2C illustrate the selective deposition of the third material 12c. For example, FIG. 2A illustrates the stopper 110c in the open state 110c₂, such that the third material 12c is deposited and surrounds the first material 12a and the second material 12b as a tube. FIG. 2B illustrates the stopper 110c in the closed state 110c₁ preventing the third material 12c from being deposited. For example, the first material 12a and the second material 12b continue to be deposited to form a midfoot portion of the molded article 300 (FIG. 6). FIG. 2C illustrates the stopper 110c returning to the open state 110c₂ for deposition of the third material 12c again. The selective deposition of the third material 12c provides the ability to control the location and amount of the third material 12c by translating the stopper 110c between the open state 110c₂ and the closed state 110c₁. The additional, third material 12c may provide added structural support or integrity to the molded article 300 at areas that may be prone to wear during use of the molded article 300. Additionally or alternatively, the additional third material 12c may be utilized to provide structural design to the molded article 300. In one non-limiting example, the third material 12c may have a greater stiffness as compared to the first material 12a and/or the second material 12b. The stopper 110c provides the ability to selectively deposit the stiffer, third material 12c in select locations, while the softer first and second materials 12a, 12b may be utilized throughout the molded article 300.

At FIG. 3, the mold assembly 202 is moved to the closed configuration to form the peripheral seal 211 around the parison 14. As shown, the distal end of the parison 14 is compressed between the mold plates 204, 206 to seal the interior cavity 18 at the distal end of the parison 14. Concurrently, the mold plates 204, 206 interface at a proximal end (i.e., adjacent to the end die 114) of the parison 14 to form the peripheral seal 211 around the parison 14 and the blow pin 116. Thus, at FIG. 3, the parison 14 is sealed at each of the distal end and the proximal end, whereby fluid can be introduced into the interior cavity 18 of the parison 14 via the conduit 118 of the blow pin 116 to expand the parison 14 into the mold plates 204, 206.

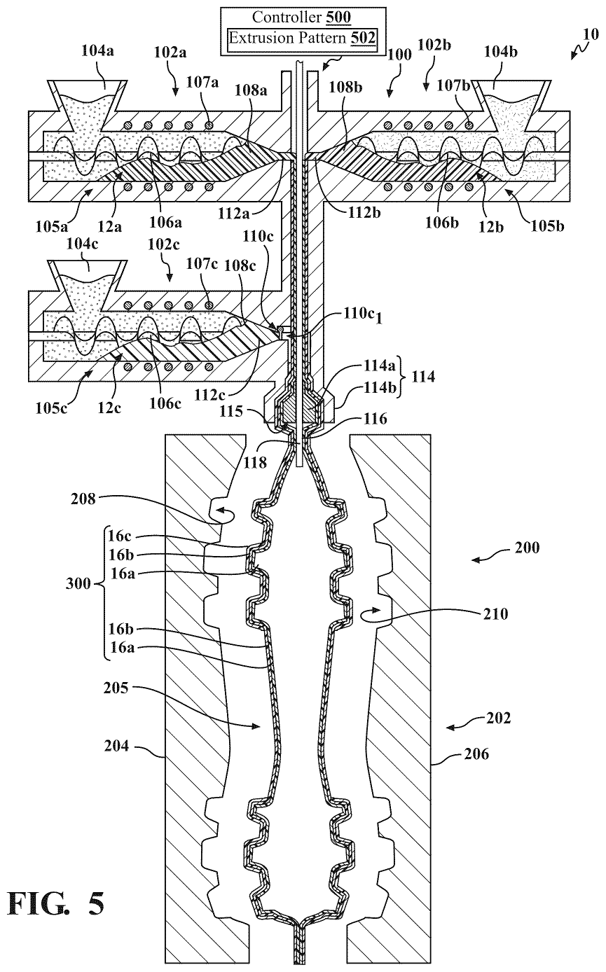

At FIG. 4, compressed air A or other pressurized fluid is introduced into the interior cavity 18 of the parison 14 via the blow pin 116 to bias the layers 16a-16c of the materials 12a-12c of the parison 14 outwardly and into the respective mold cavities 208, 210. As shown, the mold cavities 208, 210 of the illustrated example are configured to form a molded article 302 including sole plates 306, 308 having molded traction elements 314. Particularly, the first mold cavity 208 is configured to form a first sole plate 306 including a plurality of the traction elements 314 and a first sole plate body 316 (FIG. 7). The second mold cavity 210 is configured to form a second sole plate 308 including a second sole plate body 318 (FIG. 7) and a plurality of the traction elements 314. At FIG. 5, the mold assembly 202 is moved to the open configuration so that the molded article 300 including the sole plates 306, 308 can be cooled and removed from the mold chamber 205.

Referring to FIG. 6, the molded article 300 is shown after removal from the mold chamber 205. In this example, the molded article 300 includes a pair of molded article sections 302a, 302b corresponding to the number of mold plates 204, 206. Thus, the molded article 300 may include a first molded article section 302a and a second molded article section 302b joined to each other at molded article seams 304 corresponding to the joints between the mold plates 204, 206. The first molded article section 302a includes the first sole plate 306 and mold material flashing 322 associated with excess mold material of the parison 14. The second molded article section 302b includes the second sole plate 308 and mold material flashing 322 associated with excess mold material of the parison 14. As shown, the molded article seams 304 are formed within the mold flashing 322 between adjacent ones of the molded article sections 302a, 302b. Optionally, the molded article sections 302a, 302b may be separated from each other along the molded article seams 304 using a cutting tool 20. While the illustrated example shows a manual cutting tool 20 (e.g., a knife), the blow molding system 10 may include automated cutting tools, such as a die cutting device or a computer numerical control (CNC) cutting system. FIG. 7 shows the molded article 300 in a separated state including the first molded article section 302a and the second molded article section 302b.

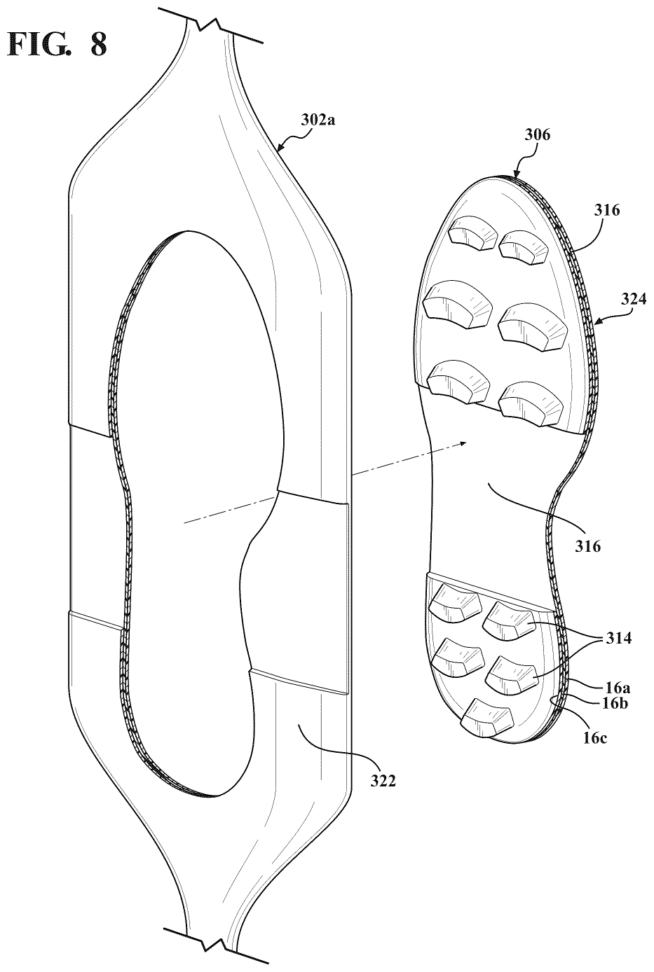

Referring to FIG. 8, the first molded article section 302a is shown in isolation for post-mold processing. In this step, the first sole plate 306 is separated from the first molded article section 302a by removing the mold flashing 322 from a first plate body periphery 324. As shown, the first sole plate 306 includes each of the layers 16a-16c of the parison 14, which cooperate to define the structure of the sole plate 306. The illustrated sole plate 306 includes a first sole plate body 312 and a plurality of traction elements 314, each including the layers 16a-16c. Again, while the illustrated examples of the sole plates 306, 308 are provided with three layers 16a-16c, any number of material layers may be incorporated into the sole plates 306, 308 by selecting a corresponding extrusion system 100 for forming a parison 14 with the desired layer configuration. Additionally or alternatively, thicknesses T16a-T16c of the layers 16a-16c may be varied and/or the layers 16a-16c may be intermittently provided in independent zones of the sole plates 306, 308. FIG. 9 illustrates an article of footwear 400 equipped with the molded article 300 as a sole component 402.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A blow molding system comprising:
a first extruder suitable for extruding a first material;
a second extruder suitable for extruding a second material, the second material cooperating with the first material to form a parison;
a stopper coupled to the first extruder and operable between an open state and a closed state, the stopper permitting passage of the first material through an extrusion path in the open state and preventing passage of the first material through the extrusion path in the closed state; and
a mold assembly operable between a first configuration defining a mold chamber and a second configuration having an opening at one end that receives the parison, the mold assembly including a plurality of mold cavities each facing the mold chamber and defining a profile of at least one sole component of an article of footwear.

2. The blow molding system of claim 1, wherein the first extruder forms a first layer of the parison and the second extruder forms a second layer of the parison, the first layer being concentric with the second layer.

3. The blow molding system of claim 2, wherein the first extruder selectively forms the first layer on the second layer when the stopper is in the open state to provide the parison with a first portion having the first layer and the second layer and a second portion having only the second layer.

4. The blow molding system of claim 2, further comprising a third extruder extruding a third material, the third material forming a third layer of the parison.

5. The blow molding system of claim 4, wherein the second extruder and the third extruder are disposed upstream of the first extruder.

6. The blow molding system of claim 4, wherein an outlet of the third extruder is disposed proximate to an inner surface of the second layer of the parison to form the third layer on the inner surface of the second layer, third layer being concentric with the second layer.

7. The blow molding system of claim 4, wherein the first material is different than at least one of the second material and the third material.

8. The blow molding system of claim 4, wherein the first material is the same as at least one of the second material and the third material.

9. The blow molding system of claim 1, wherein the plurality of mold cavities includes a first mold cavity defining a profile of a first sole plate of an article of footwear and a second mold cavity defining a profile of a second sole plate of an article of footwear and having a different configuration than the first sole plate.

10. The blow molding system of claim 1, further comprising a controller operably coupled with the stopper.

11. The blow molding system of claim 10, wherein the controller translates the stopper between the open state and the closed state to selectively apply the first material to an outer surface of the second material.

12. A method of forming a plurality of sole plates for an article of footwear, the method comprising:
extruding a first material and forming a first layer of a parison;
moving a stopper into an open state, extruding a second material, and forming a second layer of the parison;
moving the stopper into a closed state and preventing extrusion of the first material at one or more predetermined locations along a length of the first layer; and
expanding the parison in a mold chamber having a plurality of mold cavities to conform the parison to the plurality of the mold cavities and form a molded article including the plurality of the sole plates.

13. The method of claim 12, wherein moving the stopper into the open state and extruding the second material includes forming an outer layer of the parison.

14. The method of claim 12, wherein extruding the first layer and the second layer includes extruding the same material.

15. The method of claim 12, wherein extruding the first layer and the second layer includes extruding different materials.

16. The method of claim 12, further comprising extruding a third material and forming a third layer of the parison.

17. The method of claim 16, wherein forming the third layer includes forming the third layer on an opposite side of the first layer than the second layer.

18. The method of claim 16, wherein forming the third layer includes forming the third layer concentric with the second layer.

19. The method of claim 12, further comprising separating the plurality of sole plates from one another.

20. The method of claim 12, further comprising incorporating at least one sole plate of the plurality of sole plates into a sole structure.
